(19) United States
(12) Patent Application Publication
(10) Pub. No.: US 2007/0239738 A1
(43) Pub. Date: Oct. 11, 2007

(54) Method and apparatus for sorting character strings having complex characters

(76) Inventors: Robert M. Harman, Palo Alto, CA (US); Ying Y. Chang, Palo Alto, CA (US); Eugene A. Mirkin, Cupertino, CA (US)

Correspondence Address: MOTOROLA INC, 600 NORTH US HIGHWAY 45, ROOM AS437, LIBERTYVILLE, IL, 60048-5343, US

(21) Appl. No.: 11/392,511

(22) Filed: Mar. 29, 2006

(51) Int. Cl. G06F 7/00

(52) U.S. Cl. 707/100

(57) ABSTRACT

A method and apparatus (100) are provided for sorting character strings having complex characters, like accented characters for example. Complex characters having a base character and a linguistic modifier are stored (201) in decomposed form, with the base character being stored as a base data element (205) and the modifier being stored as a modifier data element (206). Elements are selected from two or more character strings and are compared (202) by referencing a look-up table (204) listing the priorities of the various elements. The character strings are then sorted (203) according to these priorities. When implemented in a computational device (101) having modifier keys (106) and character keys (105), a keypad activity detection module (107) detects actuation of keys and stores the base data elements and modifier data elements. A sort module (101) then sorts the corresponding character strings by comparing elements in an atomic, piecewise fashion by referencing the look-up table (204).

### BACKGROUND

1. Technical Field

This invention relates generally to an apparatus and method for sorting character strings, like words and phrases of a particular language, and more specifically to a method and apparatus for sorting character strings containing complex characters that include character elements and linguistic modifier elements.

2. Background Art

Many languages employ complex characters in to represent words, names, objects, and the like. A complex character involves a base component, like a specific letter, character, or symbol, and a linguistic modifier, which may be a non-character symbol, accent, or other similar mark. While the base component may have a first meaning or pronunciation standing alone, that meaning or pronunciation may be drastically altered when a linguistic modifier is added to the base component. Illustrating by way of a hypothetical, English character-based example, if the letter “a” standing alone has a first meaning, perhaps as a vowel, the base “a” with a linguistic modifier “ˆ”, expressed as “â” may have a second meaning. The second meaning may mean that the complex character is now a consonant. Alternatively, the second meaning may be a change in gender, perhaps from feminine to masculine. It is quite common for languages like Chinese, for instance, to use a single base character several different ways, with the difference coming from the presence, absence, or type of linguistic modifier.

This “multiple meanings for a single base character depending upon modifier” issue causes problems for designers of electronic devices like computers, telephones, personal digital assistants, and the like. Computer programs, which execute simple instructions and are unable to think around complex problems, are often called on to perform basic operations in a very short amount of time. While mathematical programs add and multiply, linguistic programs like word processors, e-mail programs, scheduling programs, address book programs, spreadsheet programs, file libraries, and databases must rapidly sort words, names, and other objects properly. Failure to properly sort character strings having complex characters may lead to corrupt, erroneous, or unintelligible data.

Where a complex character includes both a base and a modifier, which may occupy one display cell and may be treated as a single character unit by a user, they may be stored by a computer as two elements—a base element and a modifier element. Sorting strings that include a mix of simple and complex characters may be complicated, in that if the computer fails to properly account for the linguistic modifier, an improper sort may result. To properly account for the many variations that a single base element may have, a computer may need to either convert the two characters into a single, hybrid character prior to sorting, or it may need to perform multiple sorts and checks to ensure that the complex character strings have been sorted properly. Both the former and latter require increased processing power, which slows the overall operation of the device. Additionally, where the device is a battery powered mobile device, like a mobile phone or laptop computer, the extra processing will consume battery power, thereby reducing the overall run time between recharge cycles.

There is thus a need for an improved method and apparatus of sorting character strings that include complex characters.

### BRIEF DESCRIPTION OF THE DRAWINGS

FIG. 1 illustrates a portable electronic device in accordance with the invention.

FIG. 2 illustrates one method of sorting complex character strings in accordance with the invention.

FIG. 3 illustrates one method of sorting complex character strings in accordance with the invention.

FIG. 4 illustrates exemplary Devanagari words that may be sorted with a method or apparatus in accordance with the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to sorting character strings having complex characters. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

It will be appreciated that embodiments of the invention described herein may be comprised of one or more conventional processors and unique stored program instructions that control the one or more processors to implement, in conjunction with certain non-processor circuits, some, most, or all of the functions of sorting character strings having complex characters as described herein. The non-processor circuits may include, but are not limited to, a microprocessor, associated memory, input and output controls, signal drivers, clock circuits, power source circuits, and user input devices. As such, these functions may be interpreted as steps of a method to perform a sort of character strings having complex characters. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” In this document, relational terms such as first and second, top and bottom, and the like may be used solely to distinguish one entity or action from another entity or action without necessarily requiring or implying any actual such relationship or order between such entities or actions.

Described herein is a method and apparatus designed to simplify the sorting of character strings that contain either complex characters, like accented characters for example, or a mix of complex and simple characters. In one embodiment, complex characters are stored as a base element and a modifier element. Once the characters are stored in this deconstructed, multi-character, base plus modifier format, an atomic element-by-element sort may be performed with the assistance of a look-up table listing all of the elements, sometimes grouped in sorting blocks, in accordance with a prearranged priority.

In an atomic sort, a method or apparatus in accordance with the invention starts at the beginning of a character string and compares each element with a corresponding element selected from another character string. In each comparison, the look-up table is referenced to determine the proper priority for the compared elements. If the compared elements are the same, the next, sequential element selected from one character string is compared with its corresponding next element selected from another character string. When the compared elements are different, the table is referenced and the character with the higher priority is advanced.

In one embodiment, a manipulation of the position of the modifier characters within the look-up table facilitates prioritization from the atomic comparison. Where multiple languages or sets of characters are included in a single look-up table, the characters associated with each language may be grouped into sorting blocks. For example, a single look-up table may include a digit-sorting block containing Arabic numerals, a Roman sorting block containing corresponding letters, and a Cyrillic sorting block containing corresponding symbols. Within each sorting block may be both characters and modifiers.

By way of example, suppose that within a Devanagari sorting block are listed the characters “Fa” and “Pha”, along with the modifier “Nukta”. While a native speaker considers the character “Fa” to be independent, it is known that the character “Fa” may be constructed with the base character element “Pha” and the linguistic modifier element “Nukta”. In accordance with one embodiment of the invention, modifiers are given a lower priority than are base characters in the look-up table. Where sorting blocks within the look-up table are used, linguistic modifiers may be moved to the beginning or the end of the sorting block. Thus, the element “Nukta”, in a Devanagari table or sorting block, is moved to the end, so that “Pha+Nukta” will sort after “Pha+any other base element”.

Said differently, consider the following: Recall from the example above the characters “a” and “â”. The latter character may be expressed as a base “a” plus a modifier “ˆ”. In one embodiment of the invention, in the look-up table, base elements have a higher priority than do modifier elements. As such, it is known from consulting the look-up table that any base element will come before “ˆ”. Now consider the set of character strings below:

TABLE 1
Example Strings

| | |
|---|---|
| Character String 1 | b a c k |
| Character String 2 | b a k e |
| Character String 3 | b â c h |
| Character String 4 | b a \hat{ } c k |

A look-up table, presuming that a, â, b, c, e, h, and k comprise the entire alphabet, may look as follows:

TABLE 2
Example Look-up Table

Letter

| | a | b | c | e | h | k | \hat{ } |
|---|---|---|---|---|---|---|---|
| Priority | 1 | 2 | 3 | 4 | 5 | 6 | 7 |

While Table 2 may comprise the entire look-up table, it may alternatively be just the sorting block for this particular hypothetical (or any other) language within a larger table. As may be seen above, the “ˆ” modifier has been placed at the end of the sorting block, such that when the modifier “ˆ” is compared to a base character, the base character will take priority.

In the comparison of Character String 1 and Character String 4, the “b” and “b” elements selected from each character string, when compared, are equivalent. Moving atomically to the next character within each string, the “a” and “a” elements are also the same. Moving to the next elements, the “ˆ” modifier element is compared with the “c” base element. As the modifier has a lower priority than base characters according to the look-up table, the “b a c k” is promoted over the “b a ˆ c k”.

When Character String 2 is compared to Character String 4, the “b” and “a” character elements of the “b a ˆ c k” deconstructed string are compared, atomically, to the “b” and “a” of “b a k e”, and are found to be equivalent. When the “ˆ” modifier is compared to the “k” base element, the modifier element again has lower priority. Thus, in a sorted set of strings, Character String 2 would come before Character String 4.

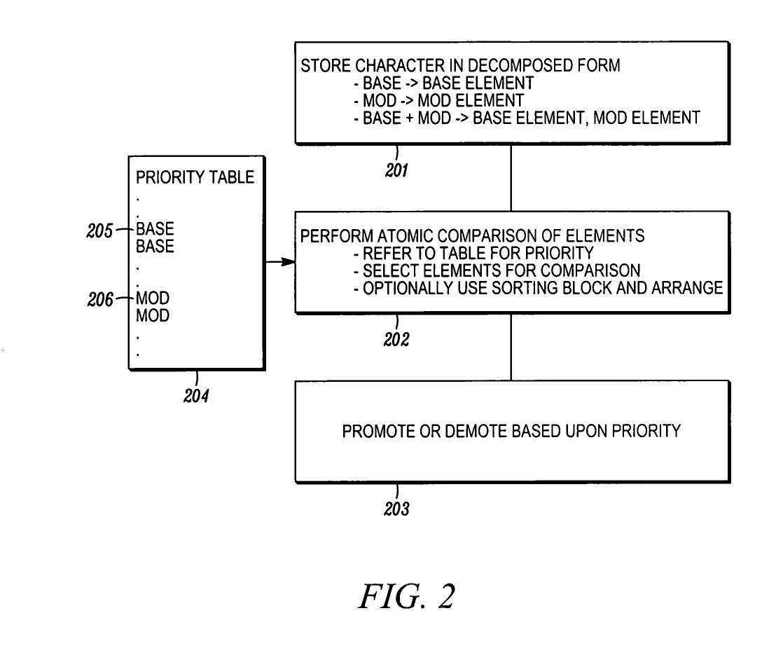

When Character String 3 is compared to Character String 4, the “â” element of Character String 3 is first decomposed into “a ˆ” as required by a sorting algorithm initialization, which is discussed below as step 201 in FIG. 2. The “b”, “a”, “ˆ”, and “c” elements from each string are compared atomically, and found to be equivalent. Finally, the comparison between the “h” and “k” elements establishes that Character String 3 will precede Character String 4.

Sorting each of the character strings atomically yields the order listed in Table 1.

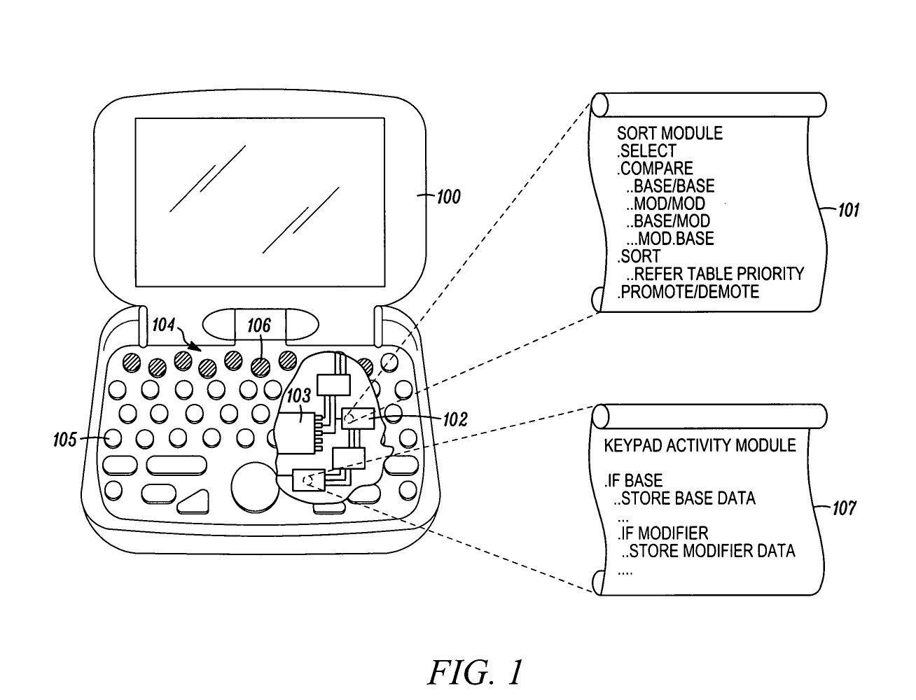

Turning now to FIG. 1 illustrated therein is an electronic device 100 having a character string sorting module 101 disposed therein in accordance with the invention. While the electronic device 100 illustrated in FIG. 1 is shown for exemplary purposes as a two-way communication device, it will be clear to those of ordinary skill in the art having the benefit of this disclosure that the invention is not so limited. The electronic device 100 may be any device configured to receive data entry, including mobile telephones, pagers, two-way radios, personal digital assistants, portable computers, and other devices.

The character string sorting module 101 may be employed as software operating within the device 100. As such, the character string sorting module may be configured as a set of software instructions stored within a memory device 102. The software commands may be operable with, and used by, a microprocessor 103 or other computational device to properly sort character strings having complex characters stored as data elements within the device 100.

The device 100 includes a keypad 104 having at least base element keys, e.g. 105, and modifier element keys, e.g. 106. The base element keys 105 may be any of symbols, characters, or letters corresponding to the alphabet of a particular language. The modifier element keys 106 may include symbols placed about base elements to alter their meaning or pronunciation, including accents, tildes, and the like. Using the example from above, where the complex character is “a ˆ”, the base element key may be the “a”, while the modifier element key would be the “ˆ”. With such a keypad 104, a user may enter either “a” or “â” without requiring a special “â” key. Separating base element and modifier keys reduces the overall size of the keypad 104.

The internal components of the portable electronic device 100 include memory 102 for storing and retrieving both instructions from executable code and data. A processor 103 may perform various operations to store, manipulate and retrieve information in the memory 102. The processor 103 and associated memory 102 are coupled to the keypad 104 such that the processor 103 is capable of detecting keypad actuation by way of a keypad activity detection module 107. The processor 103 may store characters in memory 102 for later processing, including sorting operations. For instance, where the device 100 is a personal digital assistant, the processor 103 may detect keystrokes of a user typing a memo for storage as a file in memory 102.

The keypad activity detection module 107, which may be effected in software, is operable with the processor 103 for detecting keystrokes. The keypad activity detection module 107 is configured to store character strings having complex characters as series of base elements and modifier elements. In other words, the keypad activity detection module 107 stores complex characters in decomposed form—as two elements rather than one. Thus, when a character key 105 is actuated, the keypad activity detection module 107 stores a base data element in memory 102. When a modifier key 106 is actuated, the keypad activity detection module 107 stores a modifier data element in memory 102.

The character string sorting module 101 provides an engine for sorting character strings in conjunction with the many applications operable with the device. As described in the example above, when comparing character strings, the character string sorting module 101 will begin at the beginning of the string and select data elements from two or more character strings for comparison in a piecewise fashion. Using strings “a b c” and “â b c” as an example, the character string sorting module 101 may select the first base element “a” from the first string and (following decomposition of the latter string into “a ˆ b c”) the first base element “a” from the second string.

The character string sorting module 101 then compares the selected data elements by referencing a look-up table to determine the proper priority of the compared elements. Drawing from the exemplary Table 2 above, the character string sorting module 101 determines that the “a” elements are equivalent. It then proceeds to compare the “b” base element to the “ˆ” modifier, and determines that the former has a higher priority. Upon determining this, the character string sorting module 101 sorts the character strings according to the priority of the data elements found in the table. For example, the character string sorting module 101 may, in this example, promote the character string “a b c” over the character string “â b c”. Alternatively, depending upon the configuration of the character string sorting module 101, it may demote the string “â b c” below the character string “a b c”. Either of the promotion or demotion will yield the same result: “a b c” is advanced above “â b c”.

Where the first compared elements are the same, for instance if the character strings had been “a b c e” and “a b ĉ e” and the first selected elements were “a” and “a”, the character string sorting module 101 moves to the next elements in a piecewise, atomic fashion. Thus, the next comparison would be the “b” element selected from the first string and the “b” element selected from the second string. This process continues until differing elements are detected (“ˆ” and “e”), at which point the proper priority is determined and the strings are sorted accordingly.

As the complex characters are stored in decomposed form, when at least one character string has a complex character associated therewith, the step of comparing elements in a piecewise fashion will at least once include a comparison of a modifier data element with a base data element. In one embodiment of the invention, consistent with many Indic and Asian languages, modifier data elements have a lower priority than do base data elements. Thus, using the strings “b a c k” and “b â c h” (decomposed to “b a ˆ c h”) from Table 1, when the “c” base element of the former is compared with the “ˆ” modifier element of the latter, the “c” element will have priority. As such, the character string sorting module 101 may either promote the character string associated with the compared base data element, or it may demote the character string associated with the modifier data element. In short, “b a c k” moves up and “b â c h” moves down.

Turning now to FIG. 2, illustrated therein is one embodiment of a method for sorting character strings having complex characters in accordance with the invention. The method of FIG. 2 is suitable for sorting character strings where at least one character in one of the character strings is a complex character having at least a base and a modifier. As noted above, the method may be implemented in software or other equivalent logic circuitry so as to be operable with electronic devices.

At step 201, characters are stored in a decomposed form. Said differently, each character associated with each character string is stored as either a base element, as in the case of simple characters, or as a base element and a modifier element, as in the case of a complex character. Where implemented in association with electronic circuitry, the base element may be stored as a base data element in memory, while the modifier element may be stored as a modifier data element in memory. These elements may be stored as hexadecimal, decimal, binary, or other machine-readable formats.

At step 202, an atomic comparison, as discussed above, is performed on elements associated with the character strings. When comparing elements from two or more character strings, a look-up table 204 is consulted to determine the proper priority of the elements under comparison. As noted above, the look-up table 204 may include data arranged within sorting blocks. Modifier data elements may be listed after base data elements within either the table or the sorting block. As such, the “ˆ” modifier may be prioritized after characters like “a”, “b”, and “c”.

Where the elements under comparison are the same, the next elements within the character strings are compared in a piecewise fashion. Where the characters under comparison are different, the strings will be sorted in accordance with step 203. At step 203, the character strings are sorted by either promoting a character string having an element under comparison with a higher priority, or demoting the character string having an element under comparison with a lower priority.

In one embodiment of the invention, the table 204 includes a prioritized list of base elements, e.g. 205, and modifier elements, e.g. 206. In one embodiment, the base elements 205 have a higher priority than do the modifier elements 206. As such, where the character strings are “a b” and “a ˆ b”, at step 202 the “a” element from the first string is compared with the “a” element of the second string. Since these characters are the same, the method moves in a piecewise fashion to the “b” element and the “ˆ” element. As the data element selected from the first character string is a base data element, i.e. “b”, and the data element associated with the second character string is a modifier data element, i.e. “ˆ”, step 203 may sort the corresponding character strings by either promoting the “a b” character string or demoting the “a ˆ b” character string. The reverse is also true: Where the data element associated with the first character string that is under comparison is a modifier data element, and the data element associated with the second character string is a base data element, step 203 may sort the character strings by either promoting the second character string or demoting the first character string.

One advantage of the method of FIG. 2 is that it reduces overall processing power required by an electronic device that may be executing the method by performing a sequence of software instructions. One prior art solution, for example, employs a conversion step prior to comparison, which in turn affects all variants of a character, including its unmodified base. Using the “a” and “â” characters as an example, the prior art method may build a table where “a→a1” and “â→a2”. The prior art method reads this newly created, temporary table to determine that one is greater than two, and thus promotes the “a”. The problem with this prior art solution is that it requires more processing power and more memory, in that a temporary table must be constructed for each and every comparison. The present invention omits the step of converting base characters into expanded character strings having characters representing ordinal values, where the ordinal values indicate whether characters are modified or unmodified. As such, the present invention reduces the overall processing power and memory requirement, thereby expediting sorting operations and, in the case of portable electronic device, extending battery life.

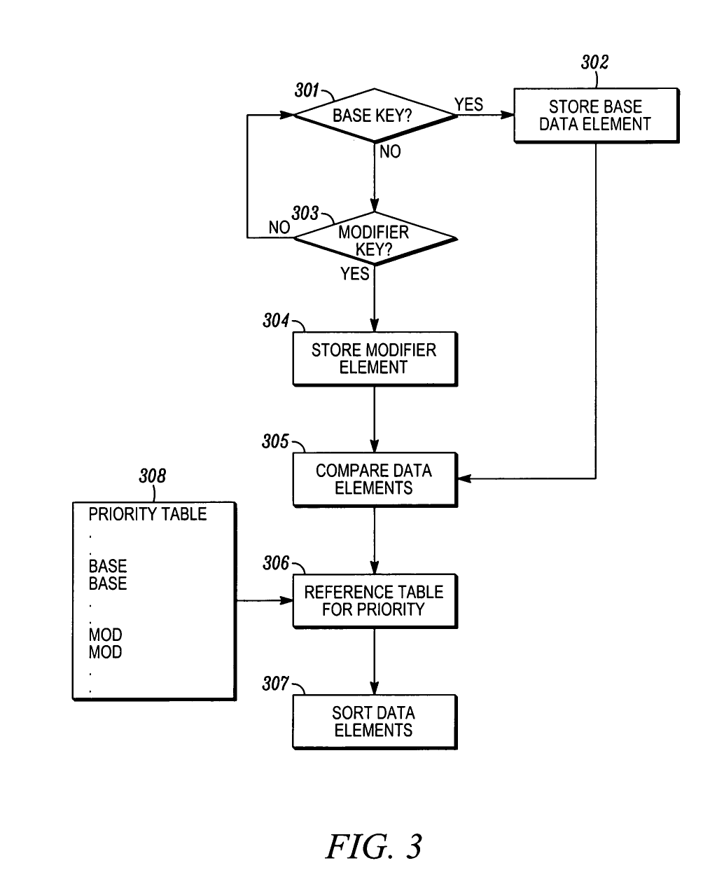

Turning now to FIG. 3, illustrated therein is a method of electronically sorting character strings suitable for use in an electronic device having a keypad with both base keys and modifier keys in accordance with the invention. As noted above, the method could be effected as a set of software instructions suitable for operation in conjunction with a processor or other logic device in a device like that of FIG. 1.

As keys of the device are actuated, characters are stored in response to keypad activity. Depending upon the combinations of keys that are actuated, these characters may be stored as character strings. At decision 301, the method checks to see whether a base key has been actuated. Where the base key has been actuated, a base data element is stored at step 302. Where a base key has not been actuated, the method moves to decision 303, where it checks to see whether a modifier key has been actuated. If so, a modifier data element is stored at step 304. By storing base data elements and modifier data elements separately, complex characters are stored in decomposed form, which is suitable for character string sorting in accordance with the invention.

The method then compares data elements selected from two or more character strings in a piecewise fashion at step 305. In one embodiment, this is done by manipulating the position of the modifier data element within a sorting block for the character string. As noted above, the modifier data elements may be moved to the end of the sorting block.

In conjunction with the comparison of data elements from the two or more character strings, the method references a look-up table 308 at step 306. The look-up table is referenced to determine a priority between the data elements under consideration. In one embodiment, the table includes a prioritized list of characters and modifiers, and the characters have priority over the modifiers. As such, when a base data element is compared to a modifier data element, the base data element, in one embodiment, will take priority.

At step 307, the method sorts the character strings with the compared data elements according to the priority gleaned from step 306. As noted above, the sorting may include either promoting a character string when the data element associated therewith has a higher priority, or demoting the character string when the data element associated therewith has a lower priority. The method thus is able to properly sort character strings having both simple and complex characters.

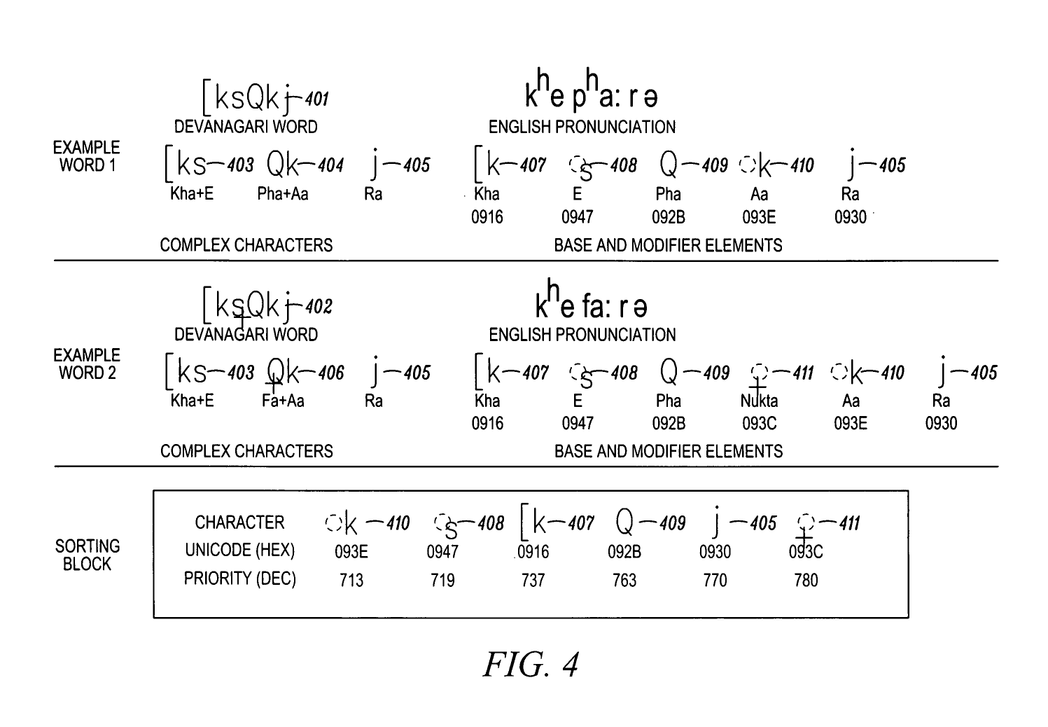

To better illustrate the methods described above by way of example, turning now to FIG. 4, consider the Devanagari words therein 401, 402. The approximate English pronunciations for these words are as follows: Word 401 is approximately /k^{h}e p^{h}a: r [symbol] , while Word 402 is approximately /k^{h}e fa: r [symbol] /. When the words are broken down into parts or cells in the way that a user would perceive them, Word 401 is made of two complex characters and one simple character: Character 403, which is the characters “Kha+E”; Character 404, which is “Pha+Aa”; and Character 405, which is the character “Ra”. Similarly, Word 402 is made of two complex characters and one simple character: Character 403; Character 406, which is “Fa+Aa”; and Character 405.

When the three characters 403,404,405 comprising Word 401, and the three characters 403,406,405 comprising Word 402, are broken into their base character elements 407,408,409,410,405 and the modifier element 411, Word 401 differs only from Word 402 by the modifier element Nukta 411 that converts “Pha+Aa” into “Fa+Aa”. In other words, the base character elements 407,408,409,410,405 of Word 401 and Word 402 are the same, except for the fact that base character element 409 in Word 402 includes the Nukta modifier 411.

Now consider a sorting operation in accordance with one embodiment of the invention. While the symbols are shown in FIG. 4, for simplicity of discussion, a corresponding table of both Word 401 and Word 402, and a sample Devanagari sorting block are shown here:

TABLE 3
Word 401 broken into electronically storable characters

| | | | Hexadecimal | |
|---|---|---|---|---|
| | | | Code | |
| Item | Name | Pronunciation | (Unicode) | Ref Des. |
| Word 401 | | k^{h}e p^{h}a: r [symbol] | | 401 |
| Base Char 1 | Kha | k^{h} | 0916 | 407 |
| Base Char 2 | E | E | 0947 | 408 |
| Base Char 3 | Pha | p^{h} | 092B | 409 |
| Base Char 4 | Aa | a: | 093E | 410 |
| Base Char 5 | Ra | r [symbol] | 0930 | 405 |

TABLE 4
Word 402 broken into electronically storable characters

| | | | Hexadecimal | |
|---|---|---|---|---|
| | | | Code | |
| Item | Name | Pronunciation | (Unicode) | Ref Des. |
| Word 401 | | k^{h}e fa: r [symbol] | | 401 |
| Base Char 1 | Kha | k^{h} | 0916 | 407 |
| Base Char 2 | E | E | 0947 | 408 |
| Base Char 3 | Pha + | F | 092B | 409 |
| Mod Char 1 | Nukta = Fa | | 093C | 411 |
| Base Char 4 | Aa | a: | 093E | 410 |
| Base Char 5 | Ra | r [symbol] | 0930 | 405 |

TABLE 5
Example sorting block subset for Devanagari

| | Unicode | | |
|---|---|---|---|
| Character | (Hex) | Priority | Ref. Des. |
| Aa | 093E | 713 | 410 |
| E | 0947 | 719 | 408 |
| Kha | 0916 | 737 | 407 |
| Pha | 092B | 763 | 409 |
| Ra | 0930 | 770 | 405 |
| Nukta | 093C | 780 | 411 |

As can be seen from Table 5, the modifier element, Nukta 411, has been moved to the end of the sorting block, with a lower priority than the base character elements 405,407,408,409,410. Note that a sorting block for the full Devanagari language would include more characters. For brevity, only those used in Word 401 and Word 402 have been included here.

When sorting the character strings associated with Word 401 and Word 402, the method first compares the Kha base character elements 403. Since they are the same, the method then considers the E base character elements 404. Since they are the same, the method then, atomically in a piecewise fashion, considers the Pha base character elements. Since they are the same, the method moves to the Aa base character element 410 from Word 401, and compares it to the Nukta modifier element 411 from Word 402. Referring to Table 5, the method determines that the Aa base character element 410 has a priority of 713, which is above the Nukta modifier element 411 has a lower priority of 780. The method thus either promotes Word 401 or demotes Word 402 for proper sorting.

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. Accordingly, the specification and figures are to be regarded in an illustrative rather than a restrictive sense, and all such modifications are intended to be included within the scope of present invention.

What is claimed is:

1. A method of sorting character strings, wherein at least one character string includes at least one character having a base and a modifier, the method comprising the steps of:
storing characters selected from the character strings in decomposed form, wherein modified characters are stored as at least a base comprising a first data element and a modifier comprising a second data element;
performing an atomic comparison of at least two data elements, wherein the atomic comparison comprises the step of referring to a table to determine a priority between compared data elements; and
sorting the character strings by one of promoting a character string when a compared data element associated therewith has higher priority and demoting the character string when the compared data element associated therewith has lesser priority.

2. The method of claim 1, wherein the table comprises a prioritized list of characters and modifiers, wherein characters have a higher priority than modifiers.

3. The method of claim 2, wherein the atomic comparison occurs in a piecewise fashion.

4. The method of claim 1, wherein the atomic comparison comprises an alphabetic sort, wherein base elements have a higher priority than modifier elements.

5. The method of claim 1, wherein the step of storing characters selected from the character strings comprises:
where a character is unmodified, storing the character as a base data element; and
where a character is modified by a modifier, storing the character as a base data element and a modifier data element.

6. The method of claim 5, wherein base data elements and modifier data elements are stored in a form selected from the group consisting of hexadecimal, decimal and binary numbers.

7. The method of claim 5, wherein the step of performing an atomic comparison comprises the step of arranging data elements associated with the character strings into a sorting block.

8. The method of claim 7, wherein the step of arranging data elements comprises placing modifier data elements after base data elements within the sorting block.

9. The method of claim 1, wherein the step of performing an atomic comparison comprises the step of selecting a data element associated with a first character string and selecting a data element associated with a second character string.

10. The method of claim 9, wherein when the data element associated with the first character string comprises a modifier data element and the data element associated with the second character string comprises a base data element, the step of sorting the character strings comprises one of promoting the second character string and demoting the first character string.

11. The method of claim 9, wherein when the data element associated with the first character string comprises a base data element and the data element associated with the second character string comprises a modifier data element, the step of sorting the character strings comprises one of promoting the first character string and demoting the second character string.

12. The method of claim 1, further comprising omitting a step of expanding the character strings to expanded character strings comprising a set of base characters and a set of corresponding ordinal values, wherein the ordinal values indicate whether the base characters are unmodified or modified.

13. In an electronic device having a keypad having both base keys and modifier keys, a method of electronically sorting character strings, the method comprising the steps of:
storing characters in response to keypad activity as character strings, wherein:
when a base key is actuated, storing a base data element; and
when a modifier key is actuated, storing a modifier data element;
comparing data elements selected from two or more character strings in a piecewise fashion;
referencing a table to determine a priority; and
sorting the character strings according to the priority of the data elements.

14. The method of claim 13, wherein the step of sorting the character strings according to the priority of the data elements comprises one of promoting a character string when a data element associated therewith has higher priority and demoting the character string when the data element associated therewith has lesser priority.

15. The method of claim 13, wherein the table comprises a prioritized list of characters and modifiers, wherein the characters have priority over the modifiers.

16. An electronic device having a character string sorting module disposed therein, the electronic device comprising:
a keypad comprising at least base keys and modifier keys;
a processor and associated memory coupled to the keypad, the processor being capable of detecting keypad actuation;
a keypad activity detection module operable with the processor and configured to store character strings as follows:
when a base key is actuated, to store a base data element in the memory; and
when a modifier key is actuated, to store a modifier data element in the memory; and
a character string sorting module operable with the processor and configured to:
select data elements from two or more character strings for comparison in a piecewise fashion;
compare the selected data elements by referencing a table to determine a priority of data elements; and
sort the character strings according to the priority of data elements.

17. The electronic device of claim 16, wherein the table comprises a prioritized list of characters and modifiers, wherein the characters have priority over the modifiers.

18. The electronic device of claim 16, wherein when the character string sorting module sorts the character strings, the character string sorting module further compares the selected data elements by at least once comparing a base data element with a modifier data element.

19. The electronic device of claim 18, wherein when the character string sorting module sorts the character strings, the character string sorting module further performs one of the operation of promoting a character string associated with the base data element and the operation of demoting a character string associated with the modifier data element.

20. The electronic device of claim 16, wherein the electronic device is selected from the group consisting of mobile telephones, pagers, two way radios, personal digital assistants and portable computers.
